(19) United States
(12) Patent Application Publication
(10) Pub. No.: US 2018/0262029 A1
(43) Pub. Date: Sep. 13, 2018

(54) PORTABLE POWER CHARGER WITH CUSTOMIZABLE AESTHETIC FEATURE

(71) Applicant: Halo2Cloud, LLC, Hartford, CT (US)

(72) Inventors: Garold C. Miller, Hartford, CT (US); Nathan Daniel Weinstein, Hartford, CT (US)

(21) Appl. No.: 15/918,018

(22) Filed: Mar. 12, 2018

Related U.S. Application Data
(60) Provisional application No. 62/470,507, filed on Mar. 13, 2017.

(51) Int. Cl. H02J 7/00; H02J 7/02; H04M 1/02

(52) U.S. Cl. CPC H02J 7/0042; H02J 7/0054; H04M 1/0202; H02J 7/025; H02J 7/02

(57) ABSTRACT

A portable charger is provided for charging one or more electronic devices from a rechargeable internal battery and includes a customizable aesthetic feature that can be secured within an indented cavity provided on a face of the charger housing. The aesthetic feature can comprise a sheet of a decorative fabric or material, or a sheet of jewels or textured material, or a sheet with lettering, a name, an image or a logo printed or embossed thereon, that can be attached to the interior surface of the indented cavity. Various attachment means can be used to secure the aesthetic feature in place, including an adhesive, suction cups, magnets, hook-and-loop fasteners, or a snap fit arrangement. A customized and personalize power charger kit can comprise a portable power charger and several interchangeable aesthetic features that can be attached to the charger housing and changed out and replaced as desired.

### CROSS-REFERENCE TO RELATED APPLICATION

This application claims the benefit of U.S. Provisional Application No. 62/470,507, filed Mar. 13, 2017, the entirety of which is incorporated herein by reference.

### TECHNICAL FIELD OF THE INVENTION

The invention relates to mobile electronic devices and, more particularly, to portable power chargers for such devices.

### BACKGROUND OF THE INVENTION

Battery-powered portable electronic devices, such as cellular phones, have become ubiquitous. Present day consumers typically own several electronic devices specifically designed for portability and use on-the-go, including, for example, a mobile phone or smart phone, a portable music player like an iPod or an MP3 player, a tablet, a portable gaming unit, a digital camera or camcorder, and the like. Also ubiquitous is a problem that the battery of a portable electronic device can run out of battery charge (i.e., become depleted) during use of the device, or while the device is being carried around. Once depleted, the battery needs to be recharged which requires the electronic device to be connected to a power source. Typically, these devices require frequent recharging, and utilize a charging cable for connecting the device to a power source, such as a wall outlet, a car charger, an airplane charger, or a computer. However, even when the device is connected to an external power source for recharging, it is difficult to continue using the device, as the device needs to remain tethered to the power source during charging.

Similarly, a separate charging cable is usually required for connecting an electronic device with a particular power source. For example, a consumer will have one cable for charging a phone at home with an AC wall socket, and another cable for charging the phone in the car using the DC car charging socket, and perhaps additional cables for charging the phone using a computer or on an airplane. Moreover, different electronic devices often utilize different connection ports and interfaces such that a single charging cable is not compatible with multiple devices. Accordingly, a tech-savvy consumer, with several electronic devices, will usually have multiple charging cables to keep track of, and find a place to store each applicable charging cable when on the move. Even then, the consumer may be without sufficient power to recharge a phone due to bad weather or a power outage, or may not always be in a place where a power source is readily available, or even if so, may not have the appropriate cable or adapter available to use with a particular power source. Furthermore, the consumer may not always be in a place where a power source is readily available, for example, if they are at the park, or may not have the appropriate cable or adapter available to use with a particular power source, for example, they are in the office but left their charging cable at home, or may be without sufficient power to recharge a phone or other device due to bad weather or a power outage.

On occasion, an electronic device needs a small amount of charge to finish a task before the device powers down due to insufficient battery capacity. For example, a user on a call using a mobile phone may wish to finish the call, but cannot find a power source to plug into, may not have enough time to get to a power source, or may not have the appropriate charging cable with her at the time. As noted, if the phone is plugged into a traditional power source, like a wall socket, it is difficult to continue using the phone as desired. Accordingly, what is needed is a power charger, even with a small boost of power, that is as portable as the electronic device and preferably easy to carry with the electronic device and the appropriate charging cable, and thus easily usable on-the-go.

Nonetheless, it is desirable to keep a charger handy and close by—where a user carries a charger, then a depleted portable electronic device can continue to be used while charging. However, where the user does not carry a charger with the device, then a depleted portable electronic device becomes unusable until the user can get to an external power source, assuming the user also has a charging cable handy for connection to the power source. Portable power chargers designed for use on-the-go must be suitable to a variety of conditions, as they are often most in need where a standard external power source is not available, and thus often needed when there is no power at all. For example, a portable power charger is especially useful when walking, camping, at the park, at the mall, or at a sporting event, where one may need to use a phone in an emergency situation. In such situations, some users may want to have chargers that are aesthetically pleasing and doesn't just look like a portable power charger or another electronic device. It is common for users to decorate their electronic devices through a variety of means—including but not limited to decorative cases, stickers, and the like. It is therefore desirable to have a portable charger that can be readily and easily modified for use as a fashion accessory.

Accordingly, in view of the foregoing, there is a need for a portable power charger usable with commonly available portable electronic devices that is easy to transport and is aesthetically pleasing so a fashion-conscious user will not be deterred from carrying it in public. Further, it is desirable to have a portable power charger with an aesthetic feature that is customizable, and even further, can be easily changed as desired. Accordingly, it is a general object of the present invention to provide a decorative portable power charger that improves upon conventional chargers on the market and overcomes the problems and drawbacks associated with such prior art charger cables.

### SUMMARY OF THE INVENTION

Embodiments of the present invention provide a portable power charger comprising a charger housing having an internally disposed rechargeable battery unit operatively connected with at least one power connection interface that can act as a power input, a power output, or both. In accordance with preferred embodiments, at least one face of the charger housing includes an indented cavity adapted to receive an aesthetic feature, for example, a sheet of a decorative fabric or material, or a sheet of jewels or textured material, or a sheet embossed or printed with a name, logo or image, that is attached to the interior face of the cavity.

The aesthetic feature can comprise multiple sheets that are interchangeable so as to customize the color, texture, pattern and/or material used for the charger housing as desired. Each sheet includes an attachment means for securing the sheet to the charger housing. For example, a backside of each sheet can include an adhesive to attach the sheet into the indented cavity. Alternatively, the backside of each sheet can include one or more suction cups, or the like, to secure the sheet to the charger housing. Still further, the face of the indented cavity and the backside of the sheet can include complementary magnets or hook-and-loop fasteners for positioning and securing the sheet in place within the indented cavity formed on the charger housing. Still further, the indented cavity can include projections or means for snap fitting the sheet into place on the charger housing. In alternative embodiments, the attachment means are releasable to allow the user to take out and change the aesthetic feature, as desired.

The power connection interface used with the charger of the present invention can comprise a power connection port or a power connection cable interface attached to the charger housing and in operative communication with the internal rechargeable battery unit. In preferred embodiments, multiple combinations of power connection ports and/or charging cables with power connection interfaces are included for connecting the portable charger with electronic devices in need of a charge and an external power source when the internal rechargeable battery unit needs a charge of its own. Where charging cables are provided, it is preferable that the charger housing includes storage cavities for housing such cables when not in use so as not to deter from the size and aesthetics of the charger, especially when not in use. When a charging cable is needed to connect to an electronic device or an external power source, the cable can be flexed out of its cavity for such connection.

In an alternate embodiment of the present invention, the charger housing can include a dedicated power input connection interface, such as an AC connection plug or a DC car charger interface.

Alternatively, charging pins can be provided on the charger housing for direct connection to a complementary power source for recharging the internal battery unit.

The power charger can also include components for wireless charging, such as a wireless transmitter to wirelessly connect to and charge an electronic device having a wireless receiver, and a wireless receiver for wirelessly receiving a charge from a wireless transmission base for recharging the internal battery unit. An indicator can be provided to indicate when the internal battery is charging, or when the capacity of the battery unit is full or empty.

A portable charger in accordance with the present invention can also include additional features such as a power indicator means, a manual power on/off button, a flashlight feature, and a flashlight power on/off button.

In general, the portable power charger can be used with a variety of devices, including but not limited to phones, tablet computing devices, portable computers, cameras, video cameras, Bluetooth devices, navigation systems, portable music players, speakers, and other portable electronics.

These and other objects, features and advantages of the present invention will become apparent in light of the accompanying drawings as described below.

### BRIEF DESCRIPTION OF THE DRAWINGS

FIG. 1 illustrates a front planar view of a portable power charger in accordance with the present invention.

FIG. 2 illustrates a perspective view of the portable power charger of FIG. 1 with interchangeable decorative sheets in accordance with an aspect of the present invention.

FIG. 3 illustrates preparing a decorative sheet for use with the portable power charger of FIG. 1 in accordance with an embodiment of the present invention.

FIGS. 4A, 4B and 4C illustrate the portable power charger of FIG. 1 with different decorative sheets installed in accordance with the present invention.

FIG. 5 illustrates a perspective top end view of the portable power charger of FIG. 1.

FIG. 6 illustrates a perspective bottom end view of the portable power charger of FIG. 1 with a decorative sheet being inserted into the indented cavity.

FIG. 7 illustrates a rear planar view of the portable power charger of FIG. 1 with charging cables extended for use.

FIGS. 8A and 8B illustrate the portable power charger of FIG. 1 using an alternate embodiment for attachment of the decorative sheets.

FIGS. 9A and 9B illustrate the portable power charger of FIG. 1 using another alternate embodiment for attachment of the decorative sheets.

FIGS. 10A and 10B illustrate the portable power charger of FIG. 1 using another alternate embodiment for attachment of the decorative sheets.

FIG. 11 illustrates a schematic for an embodiment of the portable power charger of FIG. 1 within which the customizable aesthetic feature of the present invention can be used.

### DETAILED DESCRIPTION OF THE DRAWINGS

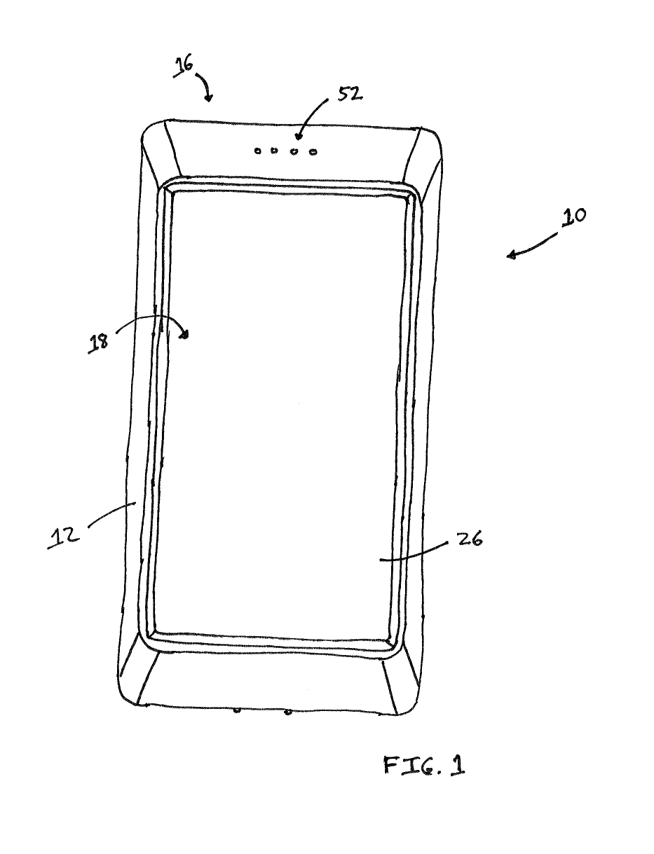

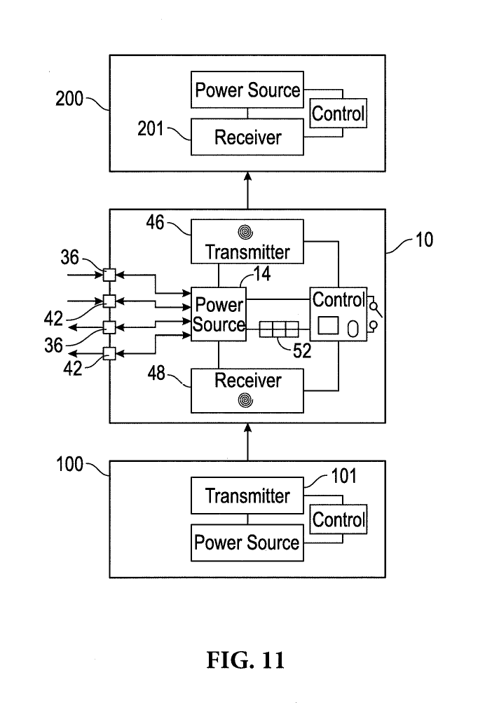

A portable power charger in accordance with embodiments of the present invention is shown in FIGS. 1-7. As illustrated, a power charger, generally designated as reference numeral 10, comprises a charger housing 12 having a rechargeable battery unit 14 (as schematically illustrated in the embodiment of FIG. 11) internally disclosed therein and in operative communication with at least one power connection interface provided on the charger housing 12.

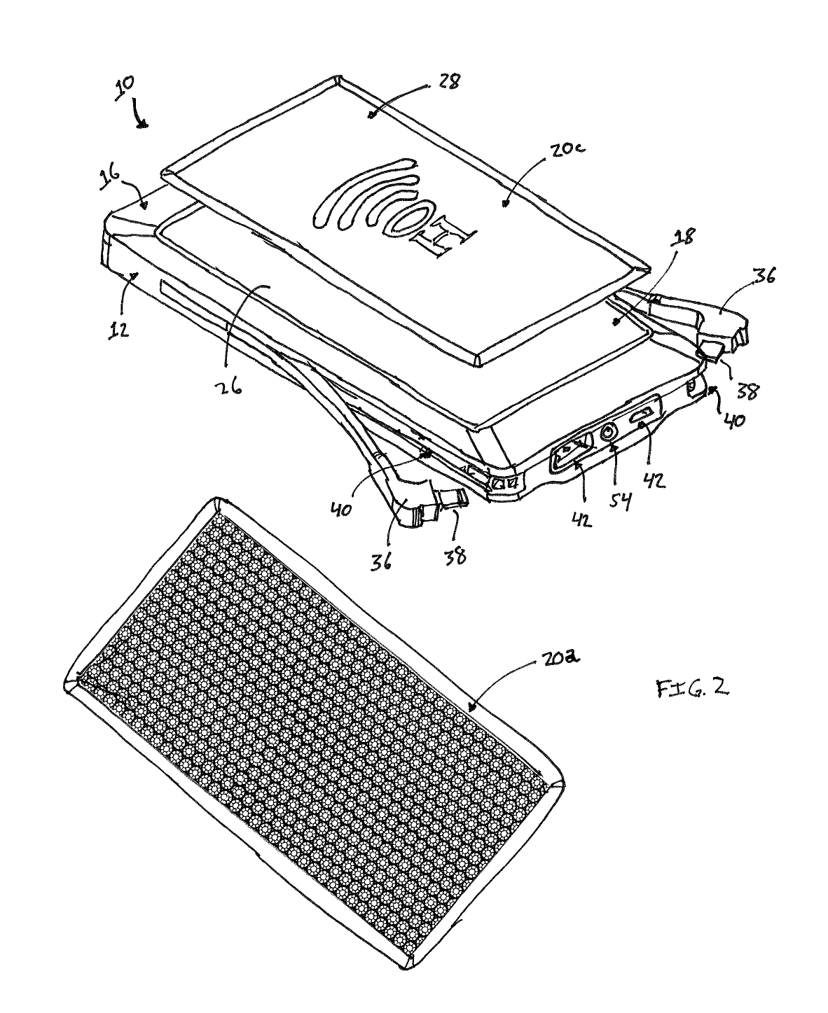

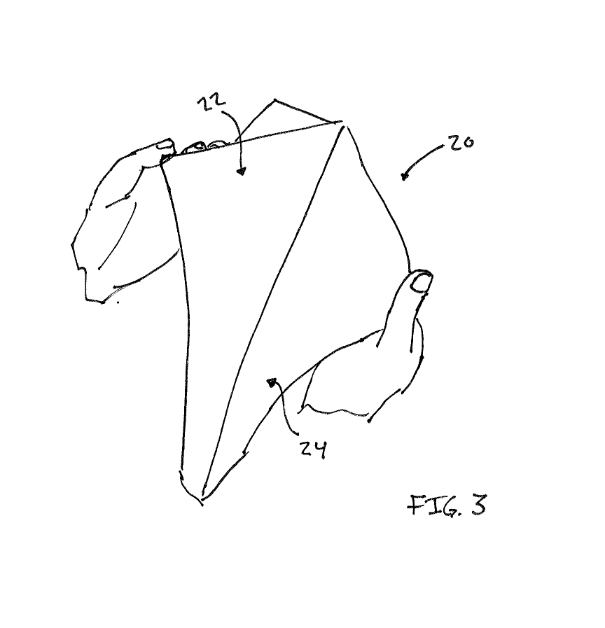

Referring to FIG. 1, the front face 16 of the charger housing 12 includes an indented cavity 18 formed therein and adapted to receive an aesthetic feature to customize and personalize the aesthetic appearance of the charger 10. The aesthetic feature, generally designated by reference numeral 20, can comprise decorative sheets with varying color, texture, material and other design features that are insertable into and secured within the indented cavity 18 of the charger housing 12. Referring to FIG. 2, one sheet 20a can comprise a piece of rhinestone- or jewel-encrusted material sized to fit within the indented cavity 18, while a second sheet 20b can be a piece of leather material . A third sheet 20c can be a sheet provided with lettering, words, a logo, a company name, graphic material, or the like. In preferred embodiments of the present invention, each sheet 20 is adapted to fit within the indented cavity 18 on the front face 16 of the charger housing 12 and be secured to the charger 10 using attachment means provided for such securement. For example, each sheet 20 can include a peel-off backing 22, as illustrated in FIG. 3, to expose an adhesive material or layer 24 for attaching the sheet 20 to the charger 10.

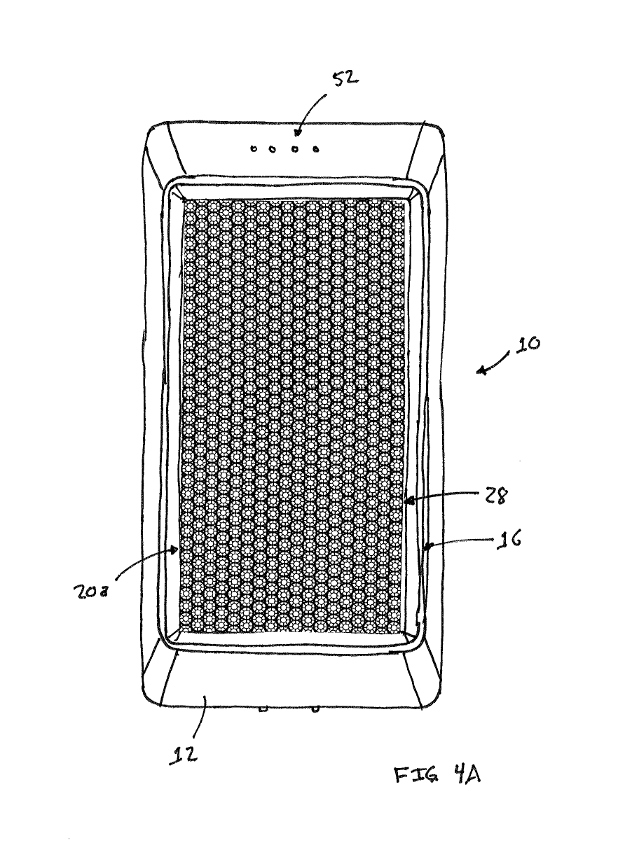

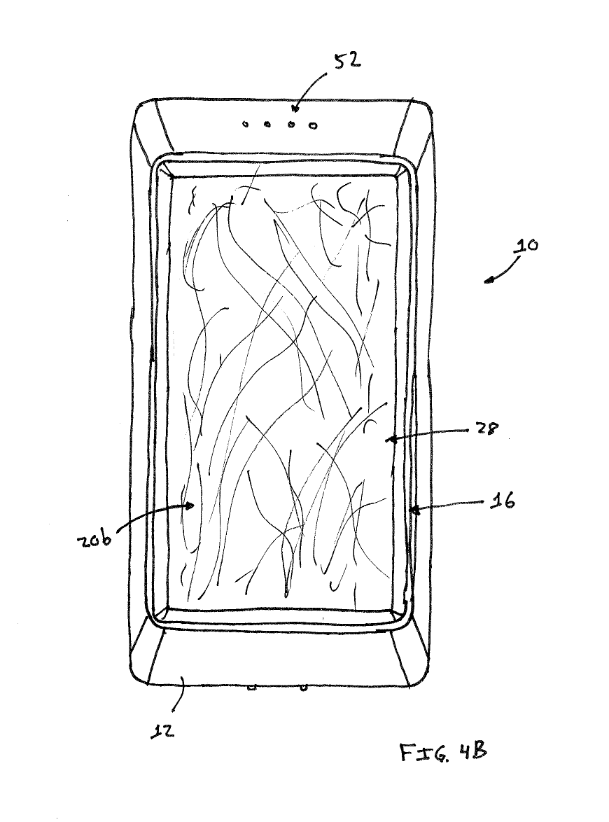

More preferably, the present invention envisions interchangeable decorative sheets 20 (see, e.g., FIGS. 4A, 4B and 4C) so that the user can customize the material, color, pattern and texture of the aesthetic feature, as desired, so as to coordinate with a purse, clothing, or the design of an electronic device with which the portable charger 10 may be used on-the-go and in public. In this regard, the attachment means releasably secure the sheet 20 to an interior surface 26 of the indented cavity 18 and permit the user to readily and easily remove the sheet 20 and replace it with another sheet, as desired.

FIGS. 4A to 4C show the same charger 10 with different decorative sheets 20a, 20b, and 20c placed and secured in the indented cavity 18 for different aesthetic appearances. Preferably, when a sheet 20 is placed within the indented cavity 18, the outer surface 28 of the aesthetic feature 20 is generally flush with the front face 16 of the charger housing 12. However, the aesthetic feature 20 can either be recessed from the front face 16 of the housing 12 or project out from the housing 12, or even provide an aesthetic texture, without departing from the spirit and principles of the present invention.

The decorative sheets 20 used as the aesthetic feature in accordance with the present invention can be flexible or rigid. They can further be made from varying materials or composites of materials.

Various known attachment means may be used to attach and releasably secure the decorative sheets 20 to the charger housing 12 without departing from the spirit and principles of the present invention. For example, as noted and illustrated in FIG. 3, an adhesive layer 24 can be provided on the back of each sheet 20 to secure the sheet 20 in place on the charger housing 12. The adhesive can be strong enough to attach the decorative sheet 20 to the housing 12, while still permitting the user to peel the sheet 20 off the housing 12 to replace with a different sheet 20. Ideally, the sheets 20 are designed for reuse.

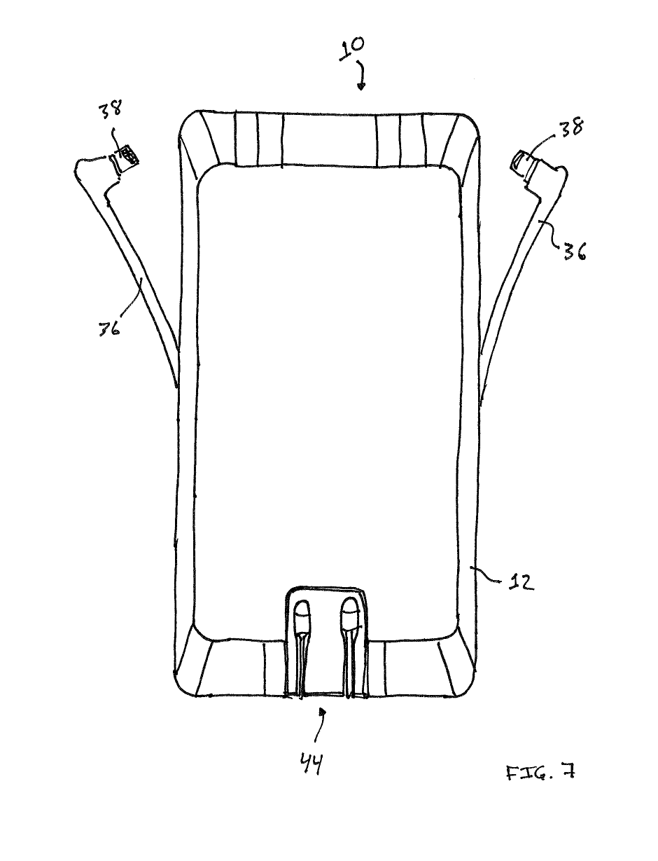

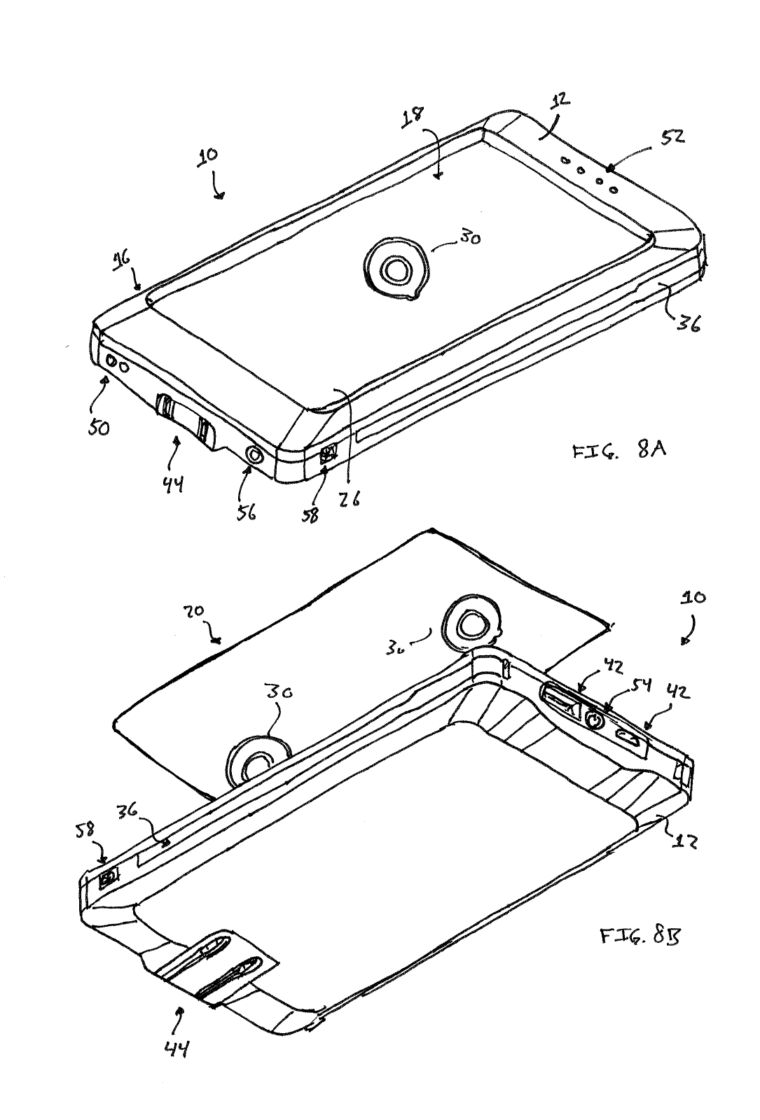

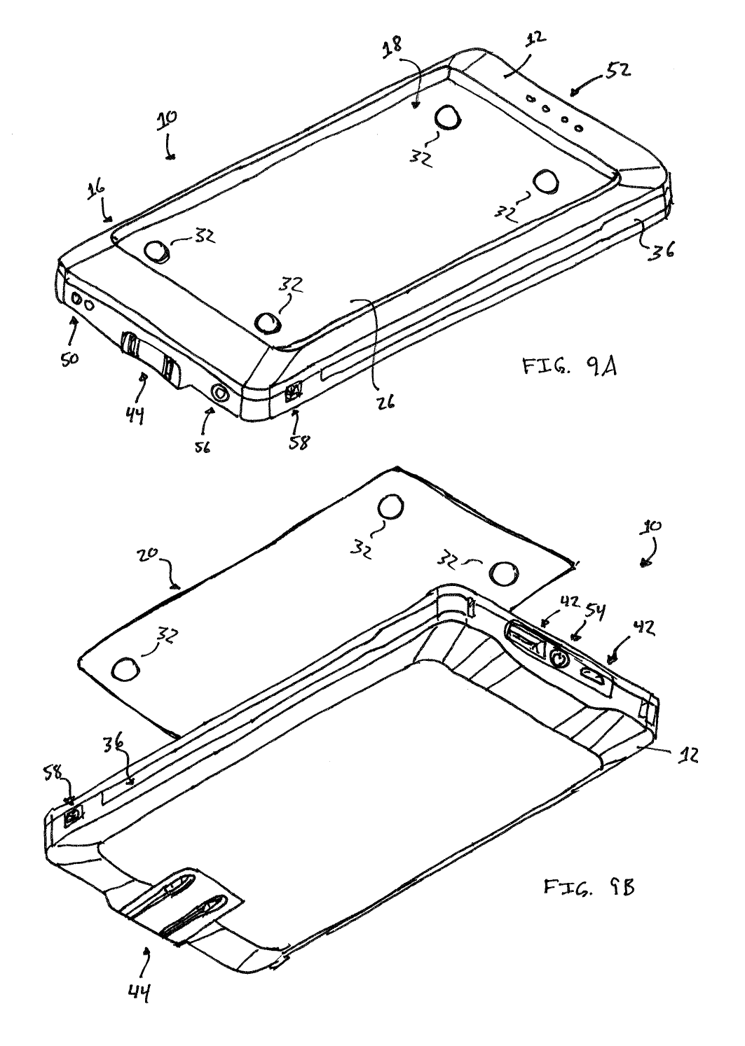

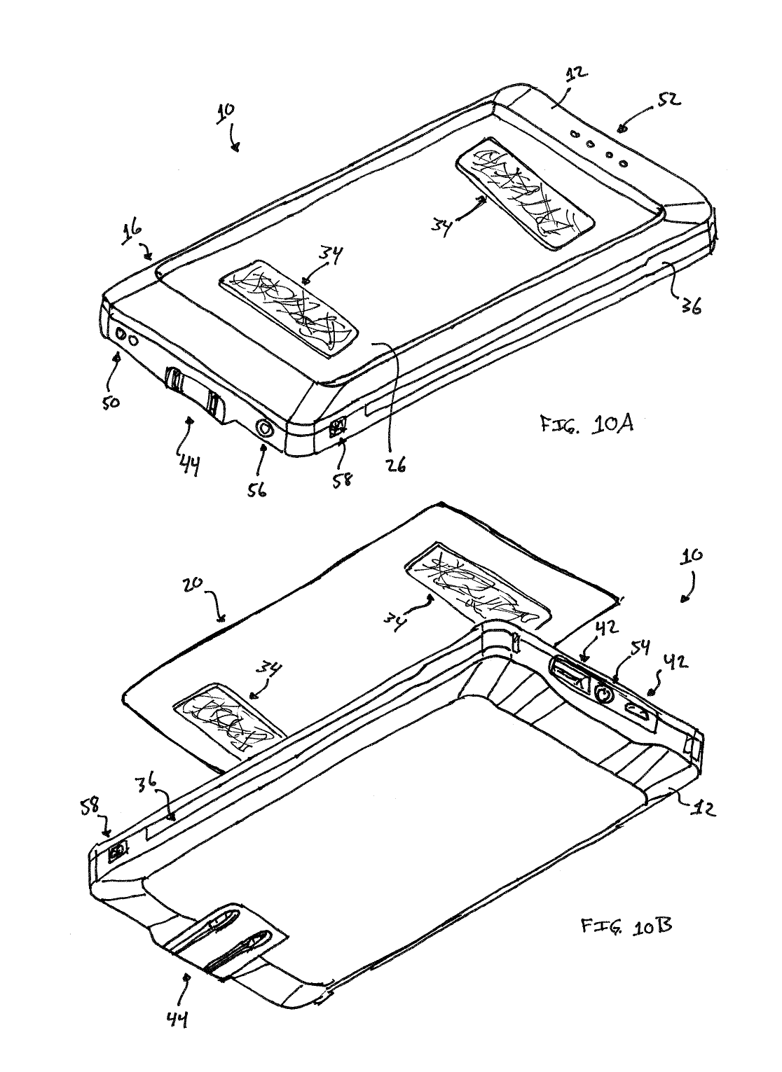

Alternatively, as illustrated in FIGS. 8A and 8B, either the decorative sheet 20 or the interior surface 26 of the indented cavity 18, or both, can be provided with one or more suction cups 30 for attachment within the indented cavity 18 of the charger housing 12. Another embodiment can utilize a magnetic attachment system, whereby complementary magnets, or combinations of magnets and metallic pieces, generally designated as reference numeral 32, are respectively provided on the interior surface 26 of the charger cavity 18 and the backside of the decorative sheet 20, as illustrated in FIGS. 9A and 9B. Further, hook-and-loop fasteners, generally designated as reference numeral 34, can be provided on the backside of the decorative sheet 20 and in the indented cavity 18, as illustrated in FIGS. 10A and 10B. Still further, the decorative sheets 20 can be generally rigid and secured within the indented cavity 18 using mechanical means, such as tabs, or snap-in connections.

As noted, the decorative sheets 20 permit a user to customize and personalize the aesthetic appearance of the portable charger 10. The material, color, texture, or pattern can be changed. Additionally, sheets 20 can comprise jewels, like rhinestones, or printed and/or embossed features, like a logo, name, image, lettering, or the like.

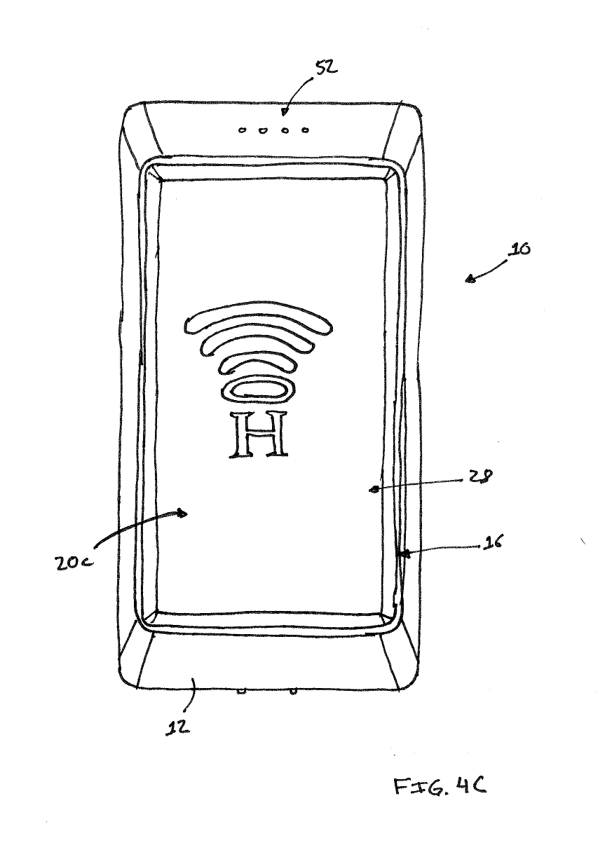

Referring to FIGS. 5-7, a particular portable power charger design with which the present invention can be used is illustrated. The aesthetic feature 20 of the present invention can be used with any charger housing design without departing from the spirit and principles of the present invention. In preferred embodiments, the charger housing 12 is provided with at least one power connection interface that can act as a power input, a power output, or both. More particularly, the power connection interface used with the charger 10 of the present invention can comprise a power connection port, or a power connection cable interface attached to the charger housing 12 and in operative communication with the internal rechargeable battery unit 14. Additionally, wireless charging components, such as a wireless transmitter, a wireless receiver and/or NFC antennas, can be provided within the charger housing 12 for transmitting or receiving a charge. In preferred embodiments, multiple combinations of power connection ports and/or charging cables with power connection interfaces and/or wireless charging components are provided for connecting the portable charger with electronic devices in need of a charger and an external power source when the internal rechargeable battery unit 14 needs a charge of its own.

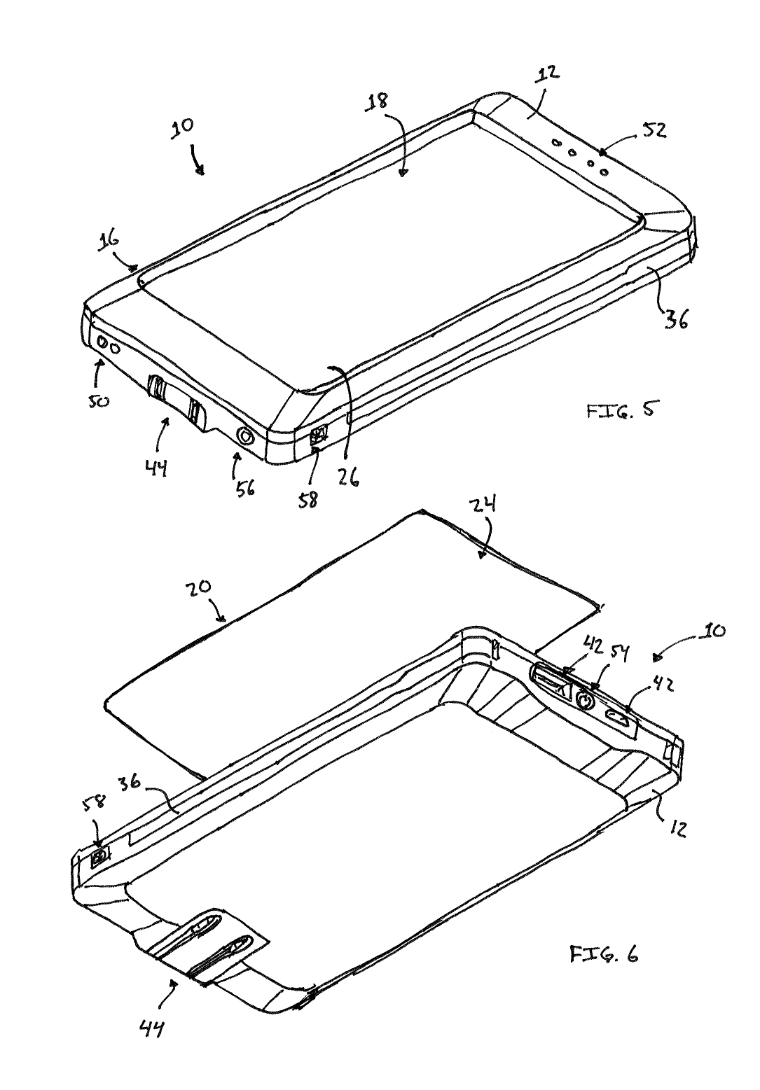

As shown in FIG. 7, the illustrated charger housing 12 includes two charging cables 36 with male power connection interfaces 38 for connection to electronic devices in need of a charge from the internal rechargeable battery unit 14 of the power charger 10. In alternate embodiments, one of the charging cables 36 can be a power input for recharging the internal rechargeable battery unit 14 when the charger 10 is connected to an external power source via the charging cable 36. Still further, one or both charging cables 36 can be designed to act as both a power input and a power output depending on what is connected to the end of the cable 36.

The illustrated charging cables 36 are adapted for storage within storage cavities 40 formed within the charger housing 12. That is, when a charging cable 36 is not needed, it can be stored within a cavity 40, as illustrated in FIG. 1, so as not to deter or detract from size or the aesthetic appearance of the charger 10. When a cable 36 is needed, it can be flexed out of its cavity 40, as shown in FIG. 2, for connection to an electronic device or an external power source.

Referring to FIG. 6, the charger housing 12 can alternatively or additionally include one or more power connection ports 42 operatively communicating with the internal rechargeable battery unit 14. Such ports 42 can operate as either a power input, a power output, or both, depending on what is connected to the port 42 via a charging cable connected thereto. In this regard, a connection port 42 can be a power input to recharge the internal rechargeable battery unit 14 if the charger 10 is connected to an external power source via the port 42. Similarly, the port 42 could be a power output for supplying a charge from the internal rechargeable battery unit 14 to an electronic device connected to the charger 10 via the port 42.

Referring again to FIG. 7, the charger 10 may further include a dedicated power input connection, such as the illustrated AC wall plug 44 that, as illustrated, can be retracted to a non-use storage position within the volume of the charger housing 12 when not needed, and pivoted out to a use position, when needed. The plug 44 is in operative communication with the internal rechargeable battery unit 14 so as to provide a charge to the battery 14 for recharging when the plug 44 is connected to a wall socket. In alternate embodiments, a DC car charger interface can be provided for recharging the internal rechargeable battery unit 14. As previously noted, one of the charging cables 36, or one of the power connection ports 42 on the charger 10 can act as a power input for recharging the internal rechargeable battery unit 14 as well when connected to an external power source.

In another embodiment of the present invention, wireless charging means can be provided within the charger housing 12 and in operative communication with the internal rechargeable battery unit 14. For example, referring to FIG. 11, a wireless transmitter 46 and/or a wireless receiver 48 can be disposed within the charger housing 12 and be operatively connected with the internal rechargeable battery unit 14 for wireless operation of the charger 10. The wireless transmitter 46 would be used for wireless connection with an electronic device 200 having a complementary wireless receiver 201 for providing a charge from the internal rechargeable battery unit 14 of the charger 10 to the electronic device. Similarly, the internal rechargeable battery unit 14 can be recharged itself, by wireless interface with a wireless transmission device 100, such as a wireless charging pad via the wireless receiver 48, which interacts with a complementary wireless transmitter 101 in the wireless transmission device 100. In general, such a charger 10 would operate in the manner as shown and described in Applicant's U.S. Pat. Nos. 9,318,915, 9,667,092 and 9,812,892, and co-pending U.S. application Ser. No. 15/725,385, each of which is incorporated herein by reference in its entirety.

Referring to FIG. 5, in alternate embodiments, power charging pins 50 can be provided on the charger housing 12 and in operative communication with the internal rechargeable battery unit 14 for direct recharging of the internal rechargeable battery unit 14 when the charger 10 is placed in or otherwise connected to a charging cradle with complementary electrical connections.

As illustrated in FIG. 1, a power indicator means 52 can be provided on the charger housing 12 to provide information about the battery capacity in the charger 10. Operation of the charger 10 can be controlled by a manual on/off button, as illustrated in FIG. 6. Alternatively, the charger 10 can automatically turn on to supply a charge once an electronic device is connected to the charger 10 via a charging cable 36, a power connection port 42, or the wireless transmitter 46, such as described in Applicant's co-pending U.S. application Ser. No. 15/826,832, which is incorporated herein by reference in its entirety.

Referring to FIG. 5, a flashlight 56, preferable using an LED, can be provided and controlled by a manual on/off button 58, illustrated on the side of the charger housing 12 proximate the flashlight 56.

The foregoing description of embodiments of the present invention has been presented for the purpose of illustration and description. It is not intended to be exhaustive or to limit the invention to the form disclosed. Obvious modifications and variations are possible in light of the above disclosure. The embodiments described were chosen to best illustrate the principles of the invention and practical applications thereof to enable one of ordinary skill in the art to utilize the invention in various embodiments and with various modifications as suited to the particular use contemplated.

What is claimed is:

1. A portable power charger with a customizable aesthetic feature comprising:
a charger housing having a rechargeable battery internally disposed therein and an indented cavity defined in a surface of the housing;
at least one power connection interface provided on the housing and in operative communication with the rechargeable battery; and
an aesthetic feature adapted to be secured in the indented cavity.

2. The portable power charger according to claim 1, wherein the aesthetic feature has an outer surface such that when the aesthetic feature is secured in the indented cavity, said outer surface is generally flush with the surface of the charger housing.

3. The portable power charger according to claim 1, wherein the aesthetic feature includes attachment means for securing the aesthetic feature to an inner surface of the indented cavity.

4. The portable power charger according to claim 3, wherein the attachment means comprises an adhesive material provided on the back surface of the aesthetic feature and positioned for engagement with the inner surface of the indented cavity.

5. The portable power charger according to claim 3, wherein the attachment means comprises at least one suction cup provided on the back surface of the aesthetic feature and positioned for engagement with the inner surface of the indented cavity.

6. The portable power charger according to claim 3, wherein the attachment means comprises at least one magnet provided on the back surface of the aesthetic feature and positioned for engagement with one of a magnet or a piece of metal located within the indented cavity.

7. The portable power charger according to claim 3, wherein the attachment means comprises complementary hook-and-loop fasteners provided on the back surface of the aesthetic feature and the inner surface of the indented cavity.

8. The portable power charger according to claim 3, wherein the attachment means comprises a snap-fit connection between the aesthetic feature and the indented cavity.

9. The portable power charger according to claim 3, wherein the aesthetic feature is releasably secured to the indented cavity so that it can be removed therefrom.

10. The portable power charger according to claim 1, wherein the at least one power connection interface is capable of operating as at least one of a power input and a power output,
wherein when said at least one power connection interface acts as a power input, an electrical charge current is provided from an external power source to the portable power charger for recharging the rechargeable battery when the portable power charger is connected to said external power source via said at least one power connection interface, and
wherein when said at least one power connection interface acts as a power output, a charge is provided from the rechargeable battery of the portable power charger to an electronic device to recharge the rechargeable battery of said electronic device when said electronic device is connected to the portable power charger via said at least one power connection interface.

11. The portable power charger according to claim 10, wherein the at least one power connection interface comprises one of a power connection port, a power connector cable, a wireless transmitter, a wireless receiver, an AC wall plug, and electrical contacts provided on the exterior surface of the charger housing, each operatively connected to the rechargeable battery.

12. A kit for customizing a portable power charger with an aesthetic feature, said kit comprising:
a charger housing having a rechargeable battery internally disposed therein and an indented cavity defined in a surface of the housing;
at least one power connection interface provided on the housing and in operative communication with the rechargeable battery; and
a plurality of interchangeable aesthetic features each adapted to be secured in the indented cavity of the charger housing.

13. The kit according to claim 12, wherein each of the aesthetic features has an outer surface such that when the aesthetic feature is secured in the indented cavity, said outer surface is generally flush with the surface of the charger housing.

14. The kit according to claim 12, wherein each of the aesthetic features includes attachment means for securing the aesthetic feature to the inner surface of the indented cavity.

15. The kit according to claim 14, wherein the attachment means comprises an adhesive material provided on the back surface of the aesthetic feature and positioned for engagement with the inner surface of the indented cavity.

16. The kit according to claim 14, wherein the attachment means comprises at least one suction cup provided on the back surface of the aesthetic feature and positioned for engagement with the inner surface of the indented cavity.

17. The kit according to claim 14, wherein the attachment means comprises at least one magnet provided on the back surface of the aesthetic feature and positioned for engagement with one of a magnet or a piece of metal located within the indented cavity.

18. The kit according to claim 14, wherein the attachment means comprises complementary hook-and-loop fasteners provided on the back surface of the aesthetic feature and the inner surface of the indented cavity.

19. The kit according to claim 14, wherein the attachment means comprises a snap-fit connection between the aesthetic feature and the indented cavity.

20. The kit according to claim 14, wherein the aesthetic feature is releasably secured to the indented cavity so that it can be removed therefrom.

21. The kit according to claim 12, wherein the at least one power connection interface is capable of operating as at least one of a power input and a power output,
wherein when said at least one power connection interface acts as a power input, an electrical charge current is provided from an external power source to the portable power charger for recharging the rechargeable battery when the portable power charger is connected to said external power source via said at least one power connection interface, and
wherein when said at least one power connection interface acts as a power output, a charge is provided from the rechargeable battery of the portable power charger to an electronic device to recharge the rechargeable battery of said electronic device when said electronic device is connected to the portable power charger via said at least one power connection interface.

22. The kit according to claim 12, wherein the at least one power connection interface comprises one of a power connection port, a power connector cable, a wireless transmitter, a wireless receiver, an AC wall plug, and electrical contacts provided on the exterior surface of the charger housing, each operatively connected to the rechargeable battery.
